(19) United States
(12) Patent Application Publication
(10) Pub. No.: US 2017/0364513 A1
(43) Pub. Date: Dec. 21, 2017

(54) DOCUMENT MANAGEMENT SERVER, DOCUMENT MANAGEMENT DEVICE, DOCUMENT MANAGEMENT SYSTEM, NON-TRANSITORY COMPUTER READABLE MEDIUM STORING DOCUMENT MANAGEMENT PROGRAM, AND DOCUMENT MANAGEMENT METHOD

(71) Applicant: FUJI XEROX CO., LTD., Tokyo (JP)

(72) Inventor: Tomohisa ISHIKAWA, Kanagawa (JP)

(73) Assignee: FUJI XEROX CO., LTD., Tokyo (JP)

(21) Appl. No.: 15/697,516

(22) Filed: Sep. 7, 2017

Related U.S. Application Data
(63) Continuation of application No. 13/557,917, filed on Jul. 25, 2012.

(30) Foreign Application Priority Data
Feb. 27, 2012 (JP) 2012-040618

(51) Int. Cl. G06F 17/30

(52) U.S. Cl. CPC G06F 17/30011

(57) ABSTRACT

Disclosed is a document management server including a storing unit that stores document information, a generating unit that generates connection information for accessing the document information stored in the storing unit, a transmitting unit that transmits the connection information generated by the generating unit to a document management device, wherein the connection information transmitted by the transmitting unit is substituted with the document information stored in the document management device.

### CROSS-REFERENCE TO RELATED APPLICATIONS

This application is a continuation application of U.S. patent application Ser. No. 13/557,917 filed Jul. 25, 2012, which in turn is based on and claims priority under 35 USC 119 from Japanese Patent Application No. 2012-040618 filed Feb. 27, 2012.

### BACKGROUND

### (i) Technical Field

The invention relates to a document management server, a document management device, a document management system, a non-transitory computer readable medium storing a document management program, and a document management method.

### (ii) Related Art

In recent years, with the spread of a communication unit such as a computer and the Internet, various server network systems in which multiple client computers and a server computer are connected via a communication unit have been proposed.

As a server network system of this type, a document management system that manages created documents is known.

### SUMMARY

According to an aspect of the invention, there is provided a document management server including: a storing unit that stores document information; a generating unit that generates connection information for accessing the document information stored in the storing unit; a transmitting unit that transmits the connection information generated by the generating unit to a document management device, wherein the connection information transmitted by the transmitting unit is substituted with the document information stored in the document management device.

### BRIEF DESCRIPTION OF THE DRAWINGS

Exemplary embodiments of the invention will be described in detail based on the following figures, wherein:

FIG. 1A is a diagram illustrating a schematic configuration of a document management system according to an exemplary embodiment of the invention, and FIG. 1B is a block diagram illustrating a schematic configuration of a document management server and a client computer;

FIG. 2 is a functional block diagram illustrating a schematic configuration of part of a document management program of the document management system according to the exemplary embodiment of the invention;

FIG. 3 is a functional block diagram illustrating a configuration of a display program used for displaying a document stored in the document management server;

FIG. 4A is a flowchart illustrating an example of the flow of a first substituting process, and FIG. 4B is a diagram illustrating an overview of the flow of the first substituting process;

FIG. 5 is a diagram illustrating an example of a display screen of document management software when a program for performing a document management process is installed in a client computer;

FIG. 6 is a diagram illustrating an example of a browser screen when a program for performing a document management process is installed in the document management server 12;

FIG. 7A is a flowchart illustrating an example of the flow of a second substituting process, and FIG. 7B is a diagram illustrating an overview of the flow of the second substituting process;

FIGS. 8A and 8B are diagrams illustrating an example of a screen for performing a selecting process;

FIG. 9A is a flowchart illustrating an example of the flow of a new document creating process, and FIG. 9B is a diagram illustrating an overview of the flow of the new document creating process;

FIG. 10 is a flowchart illustrating an example of the flow of a browsing process when document information is browsed using a shortcut created in a client computer;

FIG. 11 is a flowchart illustrating an example of the flow of a first displaying process;

FIG. 12 is a flowchart illustrating an example of the flow of a second displaying process;

FIG. 13A is a flowchart illustrating an example of the flow of a shortcut copying process, and FIG. 13B is a diagram illustrating an overview of the flow of the shortcut copying process;

FIGS. 14A and 14B are diagrams illustrating an example of a display screen for performing a copying process;

FIG. 15A is a flowchart illustrating an example of the flow of a document organizing process, and FIG. 15B is a diagram illustrating an overview of the flow of the document organizing process;

FIG. 16 is a flowchart illustrating an example of the flow of a deleting process; and

FIG. 17 is a flowchart illustrating an example of the flow of a document file acquiring process.

### DETAILED DESCRIPTION

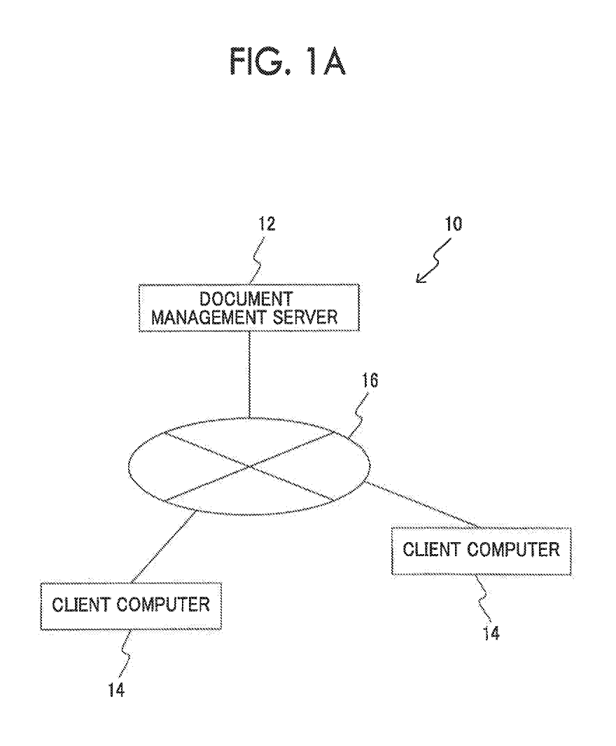

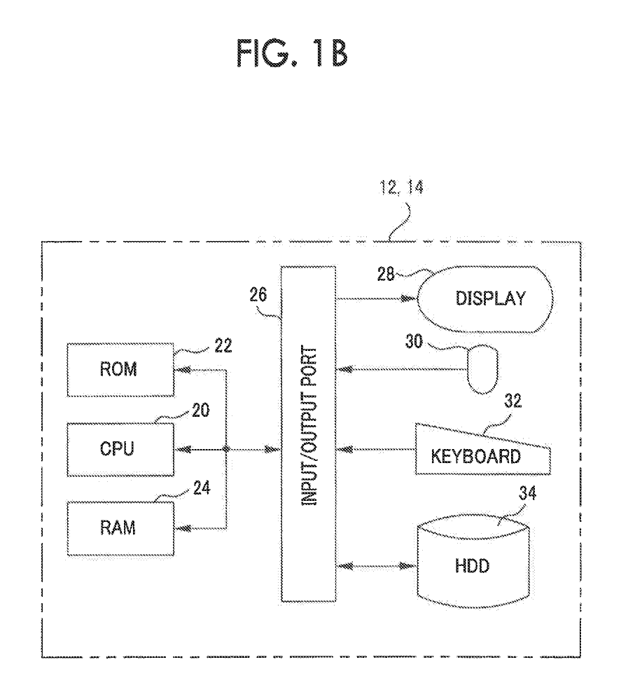

Hereinafter, exemplary embodiments of the invention will be described in detail with reference to the drawings. FIG. 1A is a diagram illustrating a schematic configuration of a document management system according to an exemplary embodiment of the invention.

As illustrated in FIG. 1A, a document management system 10 according to an exemplary embodiment of the invention is configured such that a document management server 12 and multiple client computers 14 are connected to a communication unit 16 such as a network. As the communication unit, various networks such as the Internet or the Ethernet (registered trademark) may be used. Although two client computers 14 are illustrated in FIG. 1A, the number of client computers is not limited to 2.

The document management server 12 stores the document information created by the client computer 14, the document management server 12, and the like. Moreover, the document information stored in the document management server 12 may be accessed from the respective client computers 14 connected to the communication unit 16. In the present exemplary embodiment, the document information stored in the document management server 12 is shared by multiple client computers 14 connected via the communication unit 16. For example, when document information is created by the respective client computers 14 and uploaded on the document management server 12, in the present exemplary embodiment, the document information on the client computer 14 is substituted with a shortcut to the document information stored in the document management server 12. Moreover, the user of the client computer clicks on the shortcut to access the document information stored in the document management server 12.

FIG. 1B is a block diagram illustrating a schematic configuration of the document management server 12 and the client computer 14.

As illustrated in FIG. 1B, the document management server 12 and the client computer 14 include a CPU 20, a ROM 22, a RAM 24, and an input/output port 26. A display 28, a mouse 30, a keyboard 32, and a storage device such as a hard disk (HDD) 34 are connected to the input/output port 26.

A document management program for managing the document information is stored in the hard disk 34. When the CPU 20 executes the document management program, various document management processes for managing the document information are executed.

Examples of the document management processes performed when the document management program is executed include the following processes.

(1) First document substituting process of generating a shortcut for accessing the document information stored in the document management server 12 when the document information is transmitted (uploaded) from the client computer 14 to the document management server 12 as a trigger and substituting the document information on the client computer 14 with the shortcut.

(2) Second document substituting process of uploading document information on the document management server 12 when a new document is stored on the client computer 14, the document information is sent via an email attachment, or the document information is copied, creating a shortcut thereof, and substituting the document information on the client computer 14, which has been stored, sent via an email attachment, or copied, with the created shortcut.

(3) Selecting process of selecting whether or not to upload the document information on the document management server 12.

(4) New document creating process of creating a shortcut when a user accesses the document management server 12 from the client computer 14 to create a document on the document management server 12 and transmitting the shortcut to the client computer 14.

(5) First displaying process of temporarily storing (caching) document information during browsing and displaying the cached document information when the communication unit 16 is disconnected.

(6) Second displaying process of displaying document information cached in another client computer 14 when the communication with the document management server 12 is disconnected.

(7) Shortcut copying process of creating a file copy of document information using a copy of a shortcut.

(8) Document organizing process of organizing the document information of which the shortcut is not present, or of which the number is reduced to a predetermined number.

(9) Deleting process of deleting shortcuts.

(10) Document file acquiring process of downloading document information from the document management server 12 (acquiring the ownership of the document information) and creating the shortcut thereof on the document management server 12.

The processes excluding the processes (5) and (6) among the processes (1) to (10) may be realized by executing a document management program installed in the document management server 12 or the client computer 14, and the processes (5) and (6) may be realized by executing a document management program installed in the client computer 14.

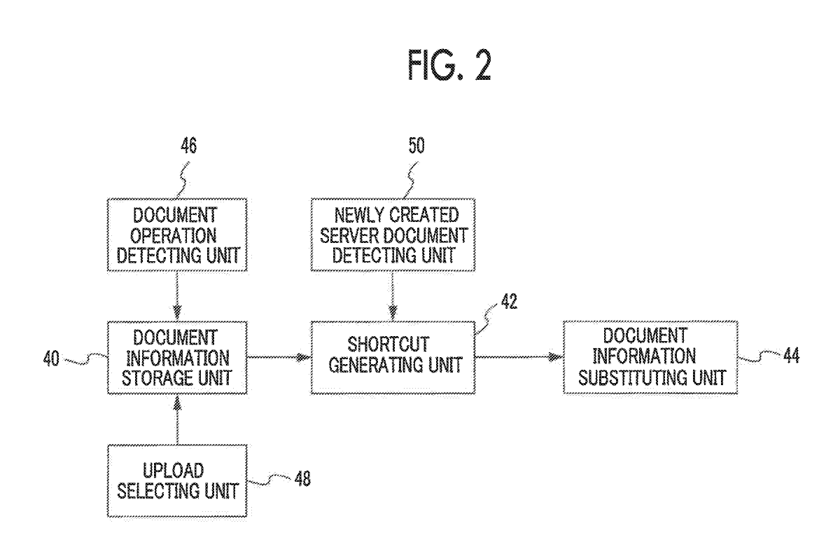

Here, a schematic configuration of the document management program of the document management system 10 according to the present exemplary embodiment will be described. FIG. 2 is a functional block diagram illustrating a schematic configuration of part of the document management program of the document management system 10 according to the exemplary embodiment of the invention. The document management program may be installed in and executed by the respective client computers 14 and may be installed in and executed by the document management server 12.

As illustrated in FIG. 2, the document management program includes the functions of a document information storing unit 40, a shortcut generating unit 42, a document information substituting unit 44, a document operation detecting unit 46, an upload selecting unit 48, and a newly created server document detecting unit 50.

The document information storing unit 40 performs a process of storing document information in a recording area such as the HDD 34 of the document management server 12 via the communication unit 16.

The shortcut generating unit 42 generates a shortcut for accessing document information when the document information is stored by the document information storing unit 40.

The document information substituting unit 44 performs a process of substituting the source document information with the shortcut generated by the shortcut generating unit 42 when the document information is stored by the document information storing unit 40. That is, since the document information of a document file is present in the document management server 12 and is accessed using the shortcut, documents will not be scattered.

Moreover, the document operation detecting unit 46 detects storing of a new document, transmission of document information via an email attachment, or copying of document information and sends a notification thereof to the document information storing unit 40 when any one of the events is detected. In response to this, the document information storing unit 40 performs a process of storing the stored document, the document transmitted via an email attachment, or the copied document in the document management server 12.

The upload selecting unit 48 selects whether or not to execute a process of storing (uploading) the document information in the document management server 12 and substituting the document information with a shortcut. In this case, the user inputs a setting on the selection using an operating unit such as a keyboard or a mouse and selects whether or not to execute the process in accordance with the setting.

The newly created server document detecting unit 50 detects whether a new document has been created on the document management server 12 and sends a notification thereof to the shortcut generating unit 42 when a new document is created. In response to this, the shortcut generating unit 42 generates a shortcut for accessing the new document and sends the shortcut to the client computer 14 of the user who created the new document.

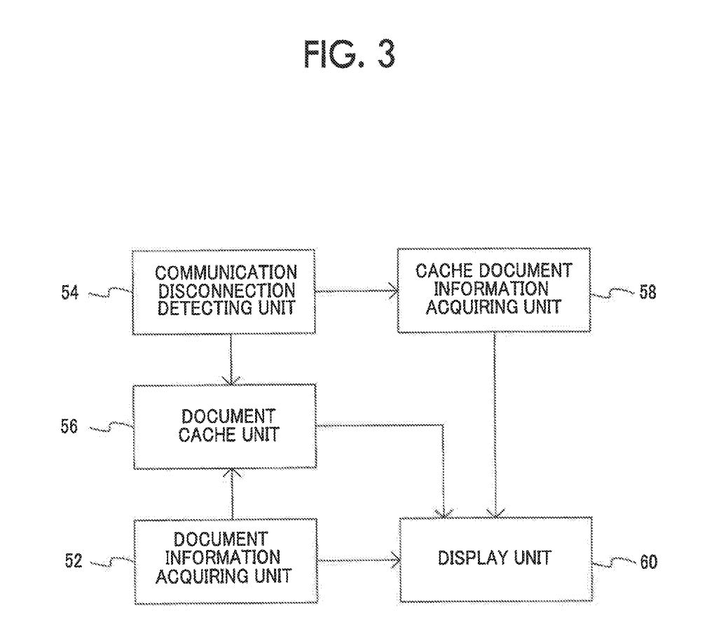

FIG. 3 is a functional block diagram illustrating the configuration of a display program used when displaying a document stored in the document management server 12. Similarly to the document management program, the display program may be installed in and executed by the client computer 14 and may be installed in and executed by the document management server 12.

The display program includes a document information acquiring unit 52, a communication disconnection detecting unit 54, a document cache unit 56, a cache document information acquiring unit 58, and a display unit 60.

The document information acquiring unit 52 performs a process of acquiring the document information corresponding to a shortcut from the document management server 12.

The communication disconnection detecting unit 54 performs a process of detecting disconnection of the communication unit 16 such as a network and sending the detection result to the document cache unit 56 and the cache document information acquiring unit 58.

The document cache unit 56 performs a process of temporarily storing the document information acquired by the document information acquiring unit 52 and using the stored document information when the communication disconnection detecting unit 54 detects the disconnection of communication. Specifically, when communication is disconnected during browsing of document information, the document cache unit 56 performs a process of enabling users to browse the document information stored temporarily therein continuously.

The cache document information acquiring unit 58 performs a process of retrieving another client computer 14, in which the document information under browsing is cached, acquiring the document information cached in the other client computer 14 so that the document information may be browsed continuously when the communication disconnection detecting unit 54 detects disconnection of communication.

The display unit 60 performs a processing of displaying document information using the document information corresponding to the shortcut acquired by the document information acquiring unit 52, the document information cached by the document cache unit 56, or the document information cached in the other client computer 14, acquired by the cache document information acquiring unit 58.

Next, a specific example of the processes performed by executing the document management program of the document management system 10 according to the exemplary embodiment of the invention will be described.

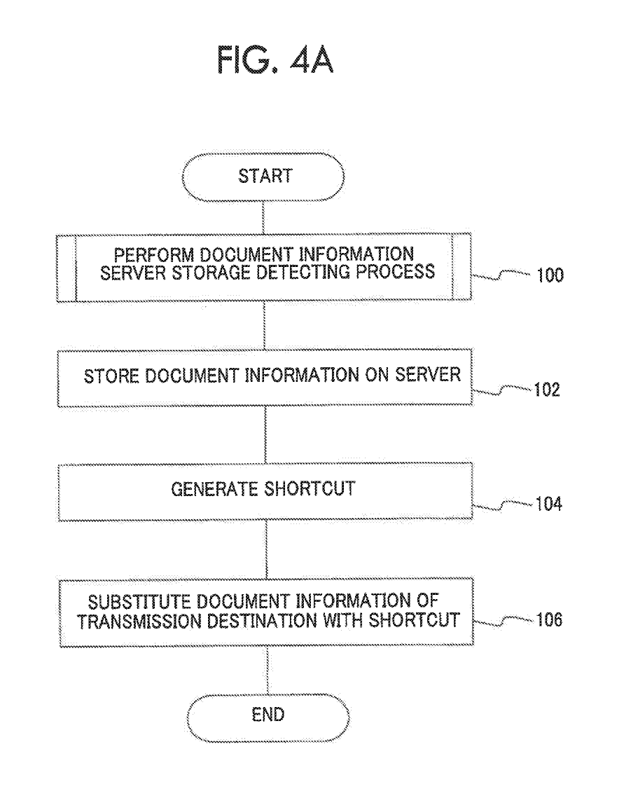

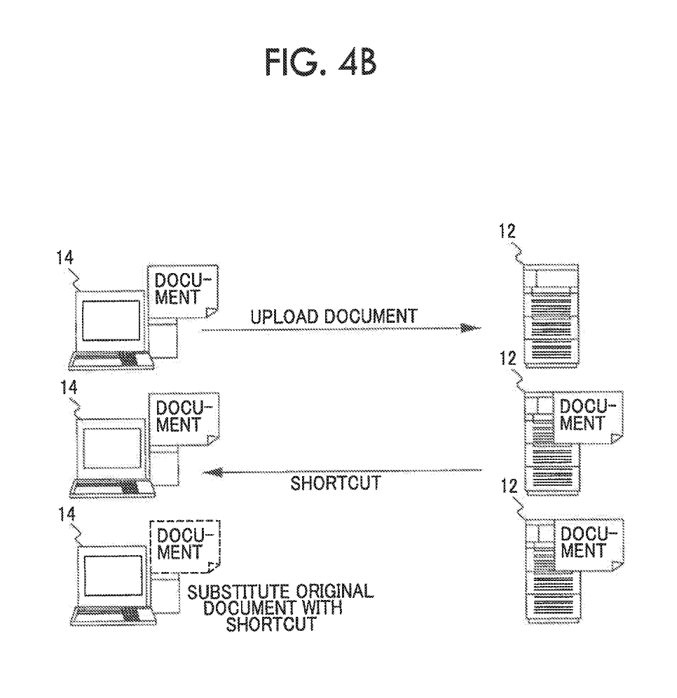

First, the first document substituting process described as an example of the document management process will be described. FIG. 4A is a flowchart illustrating an example of the flow of the first substituting process, and FIG. 4B is a diagram illustrating an overview of the flow of the first substituting process. The process of FIG. 4A is performed when execution of the first substituting process is selected in advance by the upload selecting unit 48.

In step 100, a process of detecting storing of document information on a server is performed, and the flow proceeds to step 102. In this process, in order to detect storing of the document information on the document management server 12, the document information storing unit 40 determines whether there is an instruction to store document information in the document management server 12. For example, as illustrated in FIG. 4B, it is determined whether document information has been uploaded from the client computer 14 on the document management server 12. When a positive determination result is obtained, the flow proceeds to step 102.

In step 102, the document information storing unit 40 stores document information in the document management server 12, and the flow proceeds to step 104. Here, the document information stored in the document management server 12 may be managed using identification information such as UUID. By doing so, even when multiple documents having the same file name are uploaded, the documents may be identified. When documents are identified by file names, and multiple documents having the same file name are uploaded, the following operations maybe performed. It maybe checked whether or not to overwrite the document. Uploading of the document may be rejected and an error message may be sent. If the document to be uploaded is created by the same user as the document which has been registered, the upload request may be accepted. If the two users are not identical, the upload request may be rejected. The contents and the properties of the existing document and the uploaded document may be compared. When the two documents have the same context, the uploaded document may be overwritten. When the two documents have different contexts, an error message may be sent. When the uploaded document is determined to be overwritten, since the uploaded document is treated as a document having a different context from the existing document, the user may be notified that the icon of the existing shortcut will be changed or invalidated. The updating of the icon or the notification thereof may be automatically notified from the document management server 12 with respect to the respective shortcuts, and an error message maybe sent from the document management server 12 as a response when the shortcut is clicked.

Subsequently, in step 104, the shortcut generating unit 42 generates a shortcut for accessing the stored document information, and the flow proceeds to step 106. As the content of the shortcut, at least one of an ID (for example, UUID) allocated to the document management server 12, an IP address of the document management server 12, information on the path to a document, a hash value generated from the content or the properties of a document, and a property such as a creator of a document or a created date may be used.

In step 106, the document information substituting unit 44 substitutes the source document information with the generated shortcut, and the series of processes ends. An optional method of substituting the document information with the shortcut may be used as long as the user is prevented from accessing a wrong document. For example, the source document information may be stored as a backup with a different file name. The source document information may be saved in a different directory. The source document information may be made invisible using a function of an operating system. An application that has the function of making the document information invisible may be used. The substituted shortcut is displayed as an icon similarly to normal document information present on the client computer 14, and an operation such as the transfer of a file may be performed on the shortcut. When the shortcut is displayed as an icon, the shortcut may be displayed as an icon that represents normal document information such that users are not aware that the shortcut is a shortcut. The shortcut may be displayed as an icon different from a normal icon or an icon including a specific figure or a symbol, and may be displayed as a semi-transparent document icon so that the user are aware that the shortcut is a shortcut.

As above, when document information is uploaded from the client computer 14 on the document management server 12, the source document information is stored in the document management server 12, and the document information present in the client computer 14 is substituted with a shortcut. Thus, document information will not be scattered.

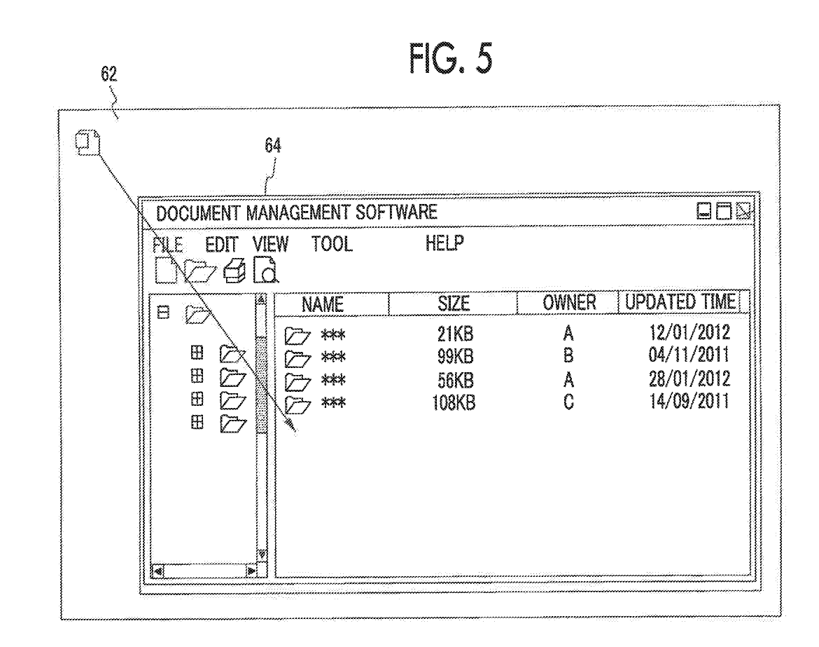

For example, when a program (the first substituting process) for performing the document management process of FIGS. 4A and 4B is installed in the client computer 14 as an application and is executed by the client computer 14, as illustrated in FIG. 5, the client computer 14 activates installed document management software 64 and uploads document information on the document management server 12 by dragging-and-dropping the document information on the activated document management software 64 from a desktop 62 or the like. In this case, the document management software 64 installed in the client computer 14 uploads the document information on the document management server 12, generates the shortcut thereof, and substitutes the document information on the desktop 62 with the shortcut.

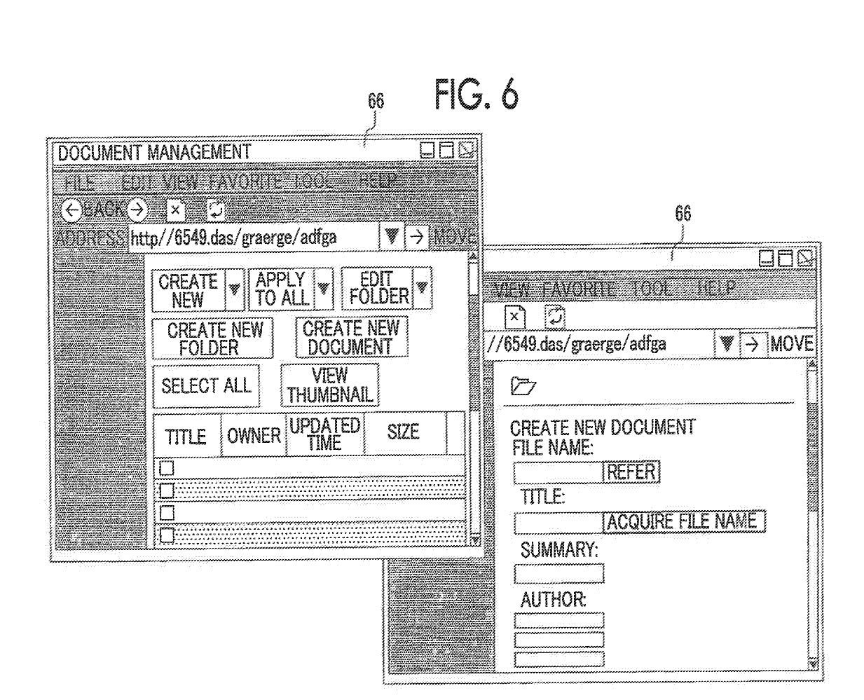

Moreover, when a program for performing the document management process of FIGS. 4A and 4B is installed in the document management server 12 and executed by the document management server 12, the program is realized by accessing the document management server 12 from the client computer 14 via a Web browser using a browser screen 66 as illustrated in FIG. 6. For example, a document information upload operation may be detected by an extension plug-in function (add-on) of a browser, and the source document information may be substituted with a shortcut. A process that monitors an operation or communication to the document information on the client computer 14 may be provided, and when an upload operation is detected, a shortcut may be transmitted from the document management server 12 to the client computer 14 and the source document information may be substituted with the shortcut. The right to access to the client computer 14 from the document management server 12 may be secured in advance, and a shortcut substituting program may be transmitted from the document management server 12.

FIG. 5 illustrates an example of a display screen of the document management application 64 when the program for performing the document management process is installed in the client computer 14. FIG. 6 illustrates an example of a browser screen when the program for performing the document management process is installed in the document management server 12.

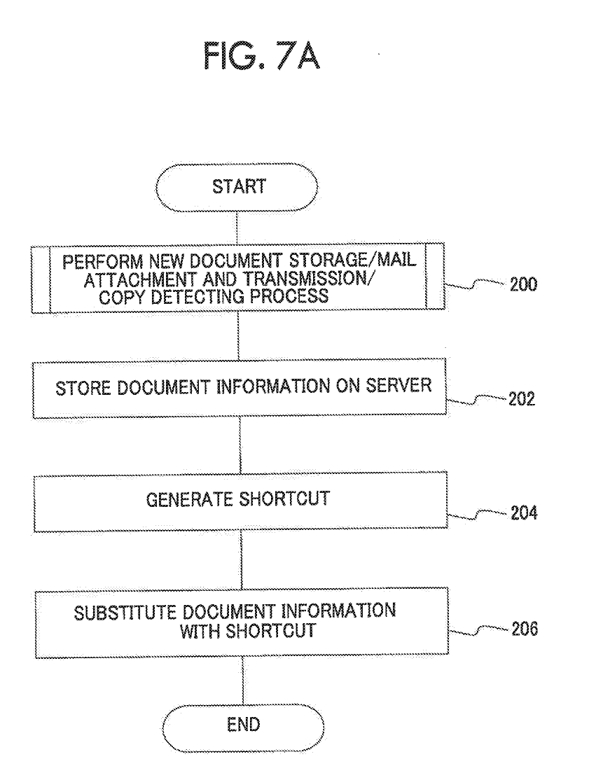

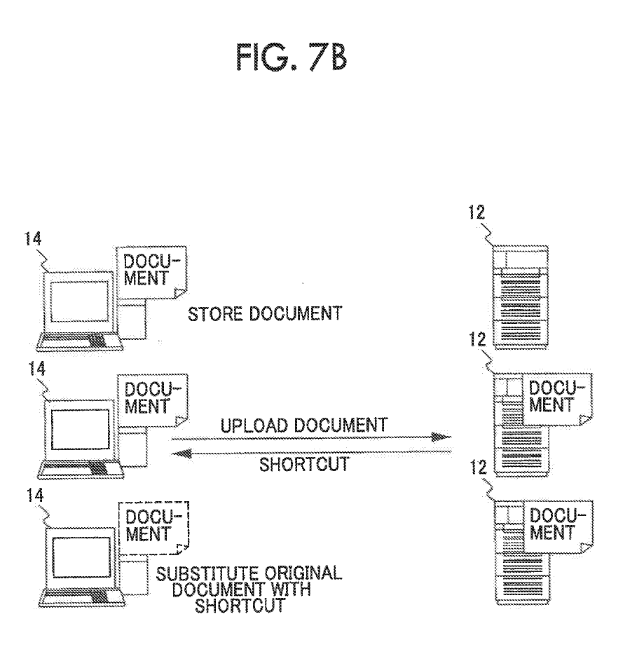

Next, the second substituting process will be described. FIG. 7A is a flowchart illustrating an example of the flow of the second substituting process, and FIG. 7B is a diagram illustrating an overview of the flow of the second substituting process.

In step 200, a process of detecting a newly stored document, transmission via an email attachment, and copying is performed, and the flow proceeds to step 202. In this process, the document operation detecting unit 46 determines whether new document information has been stored, document information has been transmitted via an email attachment, or document information has been copied. As a method of detecting storing of a document, a document application may be monitored, and a disk writing process of the client computer 14 and the written content may be monitored. Moreover, transmission of the document information via an email attachment may be detected using a plug-in mechanism of a mail application. Moreover, copying of the document information may be detected by monitoring a filer, or using a plug-in mechanism of the filer, or by monitoring a disk writing event of the client computer 14.

In step 202, the document information storing unit 40 stores the document information which has been stored, transmitted via an email attachment, or copied in the document management server 12, and the flow proceeds to step 204.

In step 204, the shortcut generating unit 42 generates a shortcut for accessing the stored document information, and the flow proceeds to step 206.

In step 206, the document information substituting unit 44 substitutes the target document information on the client computer 14 with the generated shortcut, and the series of processes ends. When the document information is transmitted via an email attachment, information other than the document information stored in the document management server 12 is substituted with the shortcut. That is, the shortcut is transmitted to a mail sender and a mail receiver.

For example, as illustrated in FIG. 7B, upon detecting a document being stored in the client computer 14, the stored document information is uploaded on the document management server 12, a shortcut to an upload destination is generated, and the document information stored in the client computer 14 is substituted with the shortcut.

When new document information is stored, document information is transmitted via an email attachment, or document information is copied, in order to prevent the creation of the document or draft from being revealed, a selecting process may be performed so as to select whether or not to execute uploading of the document information on the document management server 12. This selecting process is performed by the upload selecting unit 48.

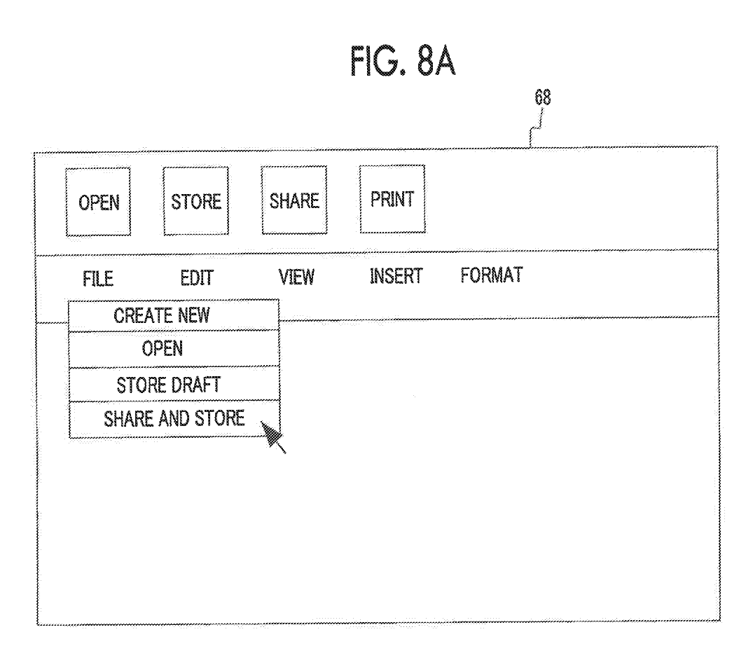

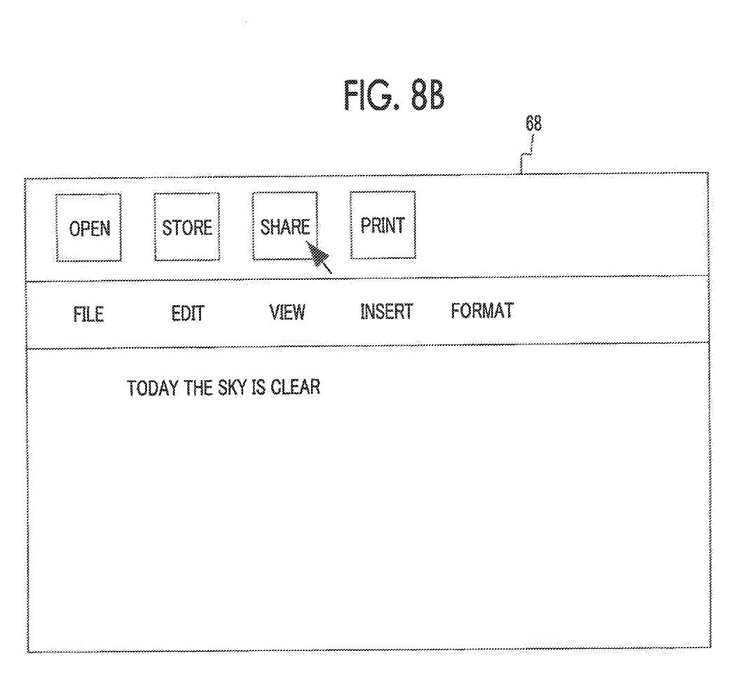

For example, as illustrated in FIGS. 8A and 8B, a selectable option such as “store draft” and “share and store” may be prepared in a menu or a toolbar on the display screen 68 of a document editing application. When “store draft” is selected, uploading on the document management server 12 is not performed. When “share and store” is selected, document information may be stored on the document management server 12, and the document information on the client computer 14 may be substituted with a shortcut.

Moreover, when copying of a document, transmission via an email attachment or the like is used as a trigger, whether or not to upload a document on the document management server 12 may be made selectable using a plug-in mechanism of a filer or a mailer. Moreover, a setting unit may be added to a disk monitoring unit.

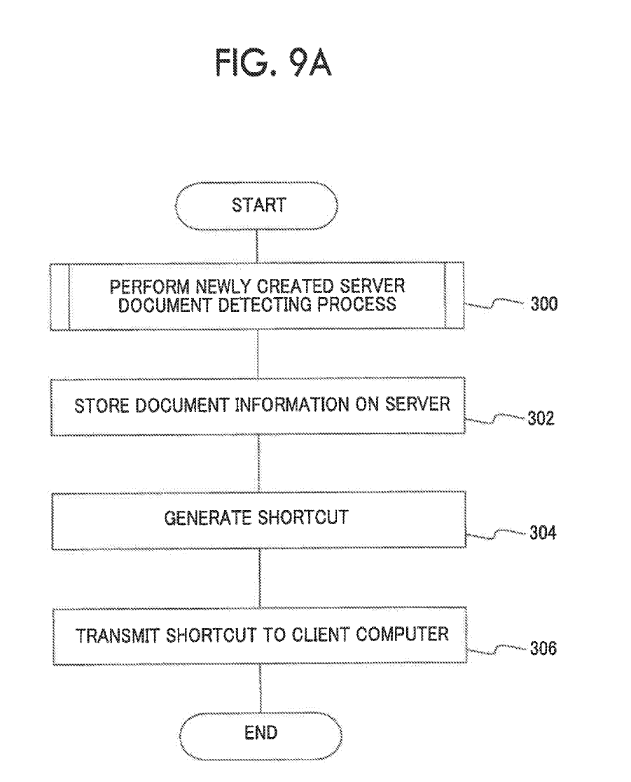

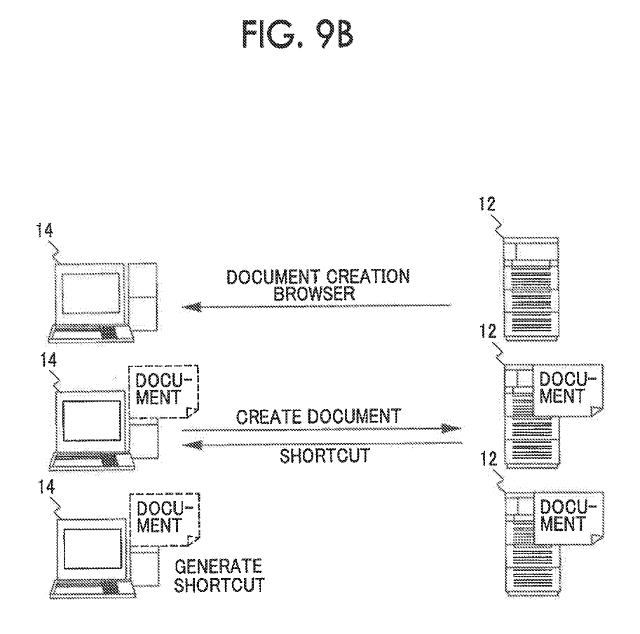

Next, the new document creating process will be described. FIG. 9A is a flowchart illustrating an example of the flow of the new document creating process, and FIG. 9B is a diagram illustrating an overview of the flow of the new document creating process.

In step 300, a process of detecting a document newly created on a server is performed, and the flow proceeds to step 302. In this process, for example, the client computer 14 activates a document editing application of the document management server 12 using a browser, and the newly created server document detecting unit 50 determines whether a new document has been created on the document management server 12. The newly created document may be detected by monitoring clicking or the like of a new document create button using an extension plug-in function of a browser that monitors operations on the document editing application of the document management server 12, for example. Alternatively, a list of documents created using the document editing application of the document management server 12 may be stored in advance in the client computer 14, and whether a new document has been created or not is detected by searching the list.

In step 302, the document information storing unit 40 stores the new document information created on the document management server 12 in the document management server 12, and the flow proceeds to step 304.

In step 304, the shortcut generating unit 42 generates a shortcut for accessing the stored document information, and the flow proceeds to step 306. A selectable option such as “store on server” and “store on server and create shortcut” may be prepared as a menu or a button so that the user of the client computer 14 may select whether or not to create a shortcut.

In step 306, the generated shortcut is transmitted to the client computer 14 that created the document information, and the series of processes ends.

For example, as illustrated in FIG. 9B, the client computer 14 creates a new document by activating the document editing application (document creation browser) of the document management server 12 on a browser. When the newly created document is detected, a shortcut for accessing the new document on the document management server 12 is created and transmitted to the client computer 14.

A selectable option such as “store on server” or “store on server and create shortcut” may be prepared as a menu or a button so that the user of the client computer 14 may select whether or not to create a shortcut.

Next, an example of the process when document information is browsed using a shortcut created in the client computer 14 by either of the above methods will be described.

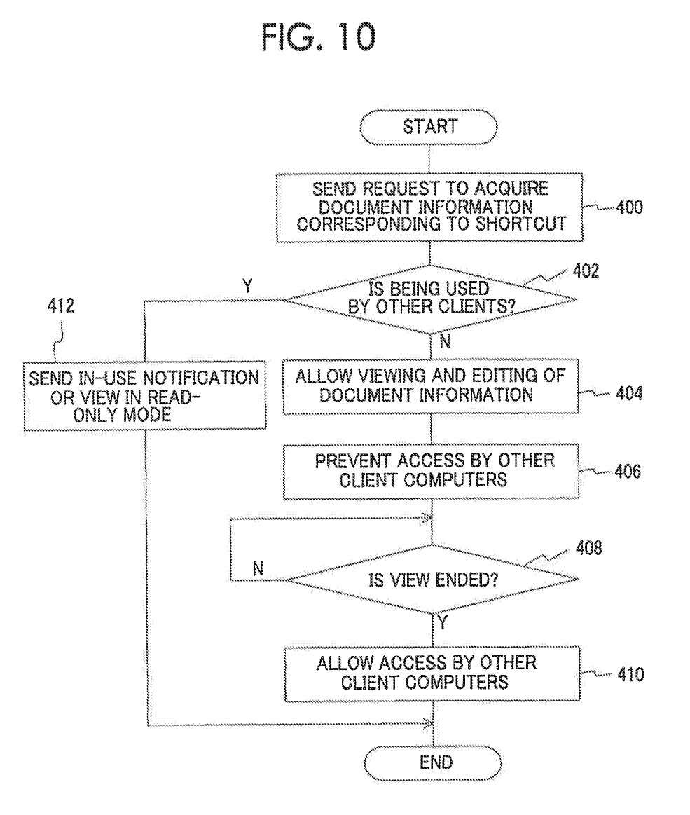

FIG. 10 is a flowchart illustrating an example of the flow of a browsing process when document information is browsed using a shortcut created in the client computer 14. The browsing process of FIG. 10 is performed by the client computer 14 and is started when a shortcut is clicked.

In step 400, the document information acquiring unit 52 sends a request to acquire document information corresponding to a clicked shortcut, and the flow proceeds to step 402.

In step 402, the document information acquiring unit 52 determines whether the requested document information is being used by another client computer 14. Specifically, the document information acquiring unit 52 determines whether the document information corresponding to the shortcut has been transmitted from the document management server 12. When a negative determination result is obtained, the flow proceeds to step 404. When a positive determination result is obtained, the flow proceeds to step 412.

In step 404, displaying and editing of the document information are enabled, and the flow proceeds to step 406. In this way, the document information corresponding to the shortcut is displayed by the display unit 60 and is edited.

In step 406, access to the document information by the other client computers 14 is prevented, and the flow proceeds to step 408. For example, a notification informing that the document information being displayed is occupied by another client computer 14 is sent to the document management server 12, whereby any other external access is prevented.

In step 408, the display unit 60 determines whether or not to stop displaying. This may be determined by determining whether editing or browsing has finished, and an operation of closing the document information has been performed. A standby is performed until a positive determination result is obtained, and the flow proceeds to step 410.

In step 410, access to the document information by the other client computers 14 is enabled, and the series of processes ends. For example, a notification informing the end of occupancy is sent to the document management server 12, whereby access from the other client computers 14 is enabled.

On the other hand, in step 412, since the document information is being used by another client computer 14, an in-use notification is sent or the document information is displayed in a read-only mode, and the series of processes ends.

By performing the displaying and browsing process using a shortcut in this way, the document information will not be accessed by multiple client computers 14 and edited simultaneously.

In the present exemplary embodiment, although it is possible to browse the document information by the browsing process of FIG. 10, the document information corresponding a shortcut is displayed in the client computer 14 by the first or second displaying process described above.

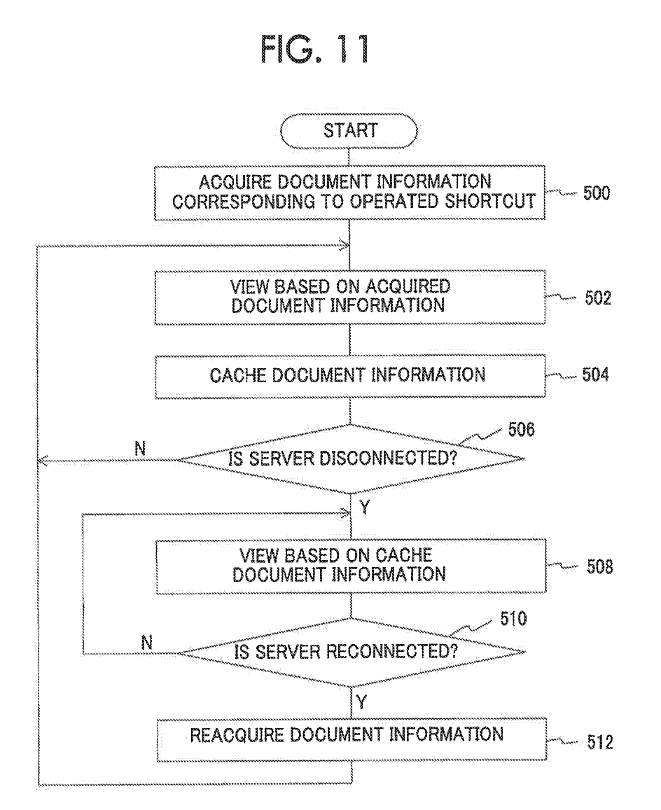

Here, the first displaying process will be described. FIG. 11 is a flowchart illustrating an example of the flow of the first displaying process.

In step 500, the document information acquiring unit 52 acquires document information corresponding to a clicked shortcut, and the flow proceeds to step 502.

In step 502, the display unit 60 displays the acquired document information, and the flow proceeds to step 504.

In step 504, the document cache unit 56 caches the acquired document information, and the flow proceeds to step 506.

In step 506, the communication disconnection detecting unit 54 determines whether the server connection is disconnected. When a negative determination result is obtained, the flow returns to step 502, and the above process is performed repeatedly. When a positive determination result is obtained, the flow proceeds to step 508.

In step 508, the display unit 60 displays the document information cached in step 504, and the flow proceeds to step 510. For example, the document information which is cached using shortcut destination information as a key is retrieved and displayed. In this way, the cached document information is displayed continuously even when communication with the document management server 12 is disconnected.

In step 510, the communication disconnection detecting unit 54 determines whether the connection to the document management server 12 has been established again. When a negative determination result is obtained, the flow returns to step 508, and the cached document information is displayed continuously. When a positive determination result is obtained, the flow proceeds to step 512.

In step 512, the document information acquiring unit 52 acquires the document information again. Then, the flow returns to step 502, and the above process is performed repeatedly.

The time when the document information is cached is not limited to the above. For example, the client computer 14 that created original document information may store the original document information as a cache when the document information is substituted with a shortcut.

Moreover, the cached document information may be deleted when a predetermined volume or number has reached. In this case, the following deleting methods maybe used. The document information of which the last date when the document information is referred to via a shortcut is oldest may be deleted first (this method is referred to as an LRU method). The document information which is least frequently referred to via a shortcut may be deleted first. For example, if a document A which is frequently used and a document B which is scarcely used are accessed in a manner of “AAAAABAAAAAAAAB,” the document A will be deleted in the LRU method, whereas the document B will be deleted in this method. The document information of which the updated date of the corresponding document file is oldest may be deleted first (in this case, it is assumed that a frequently updated document is also frequently used). The document information of which the size is largest maybe deleted first (in this case, a cache capacity is prioritized). The document information created by other users may be deleted first (in this case, it is assumed that the user who created the document will update the document information frequently and will also use the same frequently).

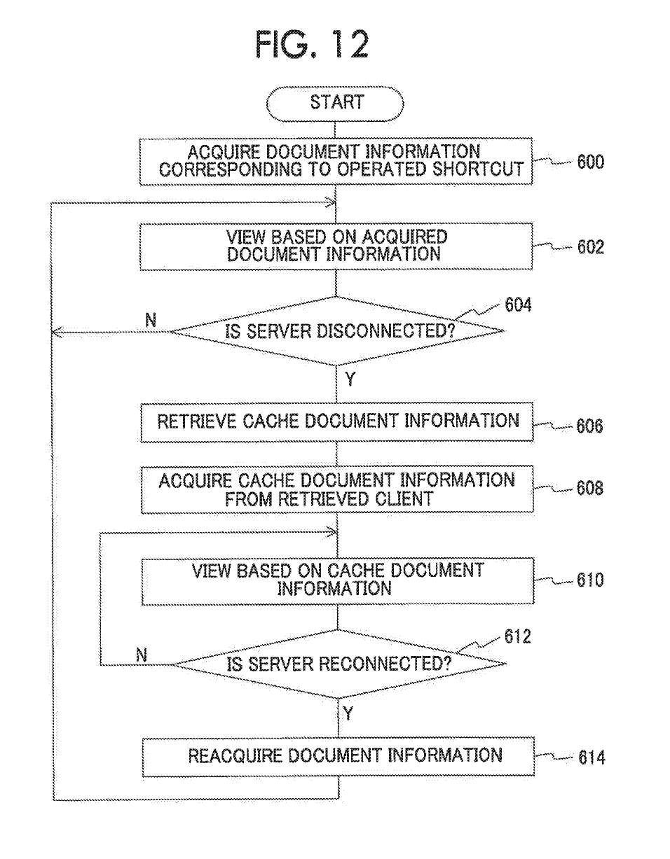

Next, the second displaying process will be described. FIG. 12 is a flowchart illustrating an example of the flow of the second displaying process.

In step 600, the document information acquiring unit 52 acquires document information corresponding to a clicked shortcut, and the flow proceeds to step 602.

In step 602, the display unit 60 displays the acquired document information, and the flow proceeds to step 604.

In step 604, the communication disconnection detecting unit 54 determines whether the server connection is disconnected. When a negative determination result is obtained, the flow returns to step 602, and the above process is performed repeatedly. When a positive determination result is obtained, the flow proceeds to step 606.

In step 606, the cache document information acquiring unit 58 searches the client computers 14 for cached document information, and the flow proceeds to step 608. The cache document information acquiring unit 58 acquires the cached document information from the searched client computer 14, and the flow proceeds to step 610. When retrieving the cached document, a list of client computers 14 which have a shortcut to the document information is examined, for example. The list maybe received in advance from the document management server 12, stored as a property of a shortcut when the shortcut is created, or stored in the client computer 14 when the shortcut is created. The client computer 14 from which the cached document information may be acquired most efficiently is retrieved. For example, first, the document information cached in the subject device is acquired. After that, the client computer 14 in which the shortcut is created most recently is selected, or the client computer 14 which provides a fastest communication speed is selected. When there is document information cached in the selected client computer 14, the document information is acquired. When there is no document information cached in the selected client computer 14, the cached document information is acquired from the other client computers 14.

In step 610, the display unit 60 displays the acquired cached document information, and the flow proceeds to step 612.

In step 612, the communication disconnection detecting unit 54 determines whether the connection to the document management server 12 has been established again. When a negative determination result is obtained, the flow returns to step 610, and the cached document information is displayed continuously. When a positive determination result is obtained, the flow proceeds to step 614.

In step 614, the document information acquiring unit 52 acquires the document information again. Then, the flow returns to step 602, and the above process is performed repeatedly.

Whether the first displaying process or the second displaying process will be executed may be set in advance. The second displaying process may be performed when the other client computers 14 may be accessed. The first displaying process may be performed when the other client computers 14 may not be accessed.

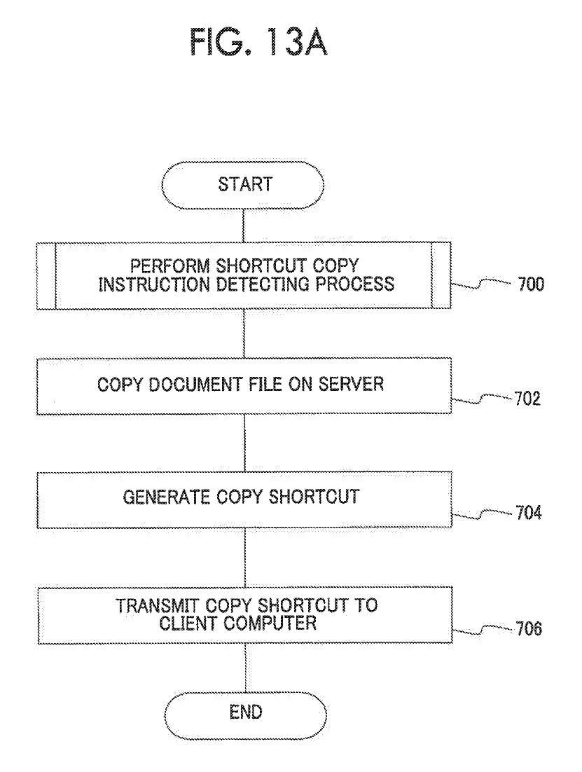

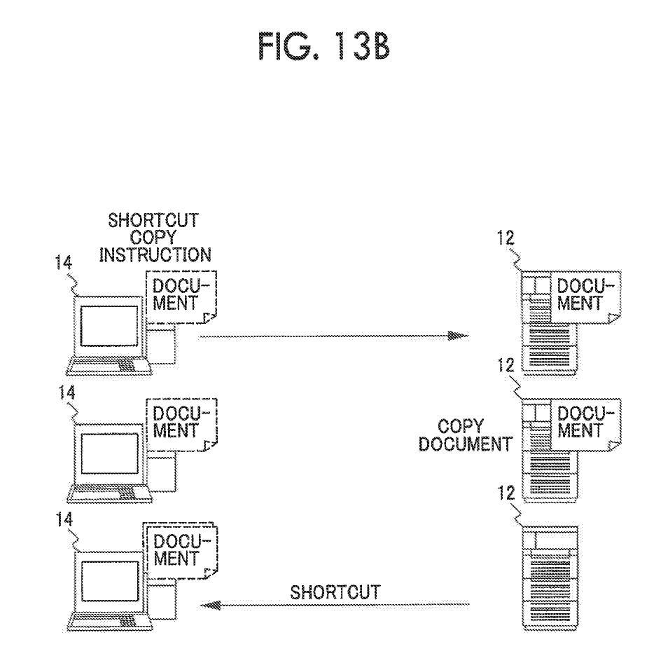

Next, a shortcut copying process will be described. FIG. 13A is a flowchart illustrating an example of the flow of the shortcut copying process, and FIG. 13B is a diagram illustrating an overview of the flow of the shortcut copying process.

In step 700, a process of detecting a shortcut copy instruction is performed, and the flow proceeds to step 702. This process is performed by determining whether there is an instruction to copy a shortcut on the client computer 14.

In step 702, new document information obtained by copying a document file on the document management server 12 is generated, and the flow proceeds to step 704. The copied file may have a file name such that users may understand that the file has been copied.

In step 704, the shortcut generating unit 42 generates a shortcut for accessing the copied document information, and the flow proceeds to step 706.

In step 706, the generated shortcut is sent to the client computer 14 that issued the copy instruction, and the series of processes ends.

For example, as illustrated in FIG. 13B, when an instruction to copy a shortcut is received from the client computer 14, and this instruction is detected, a copy of the document information corresponding to the shortcut is generated, and a shortcut for accessing the copied document information is generated and transmitted to the client computer 14.

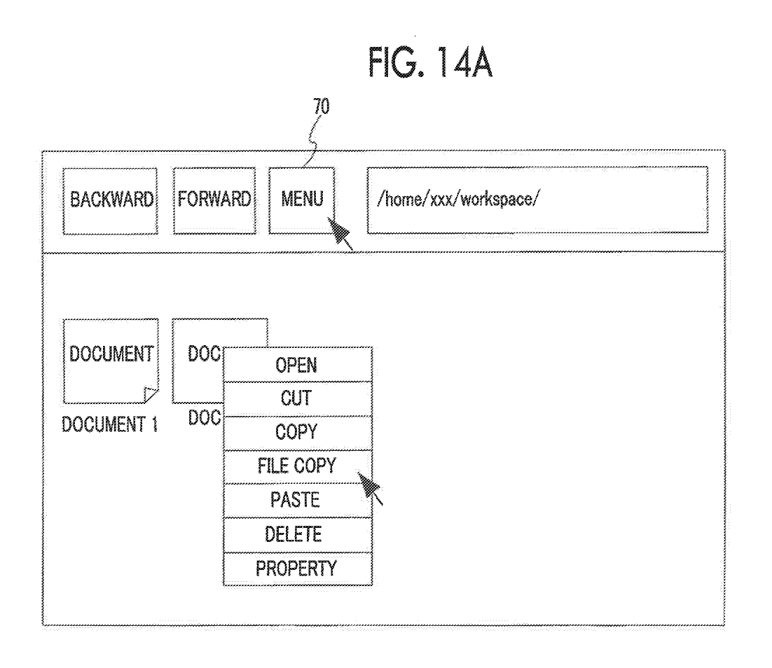

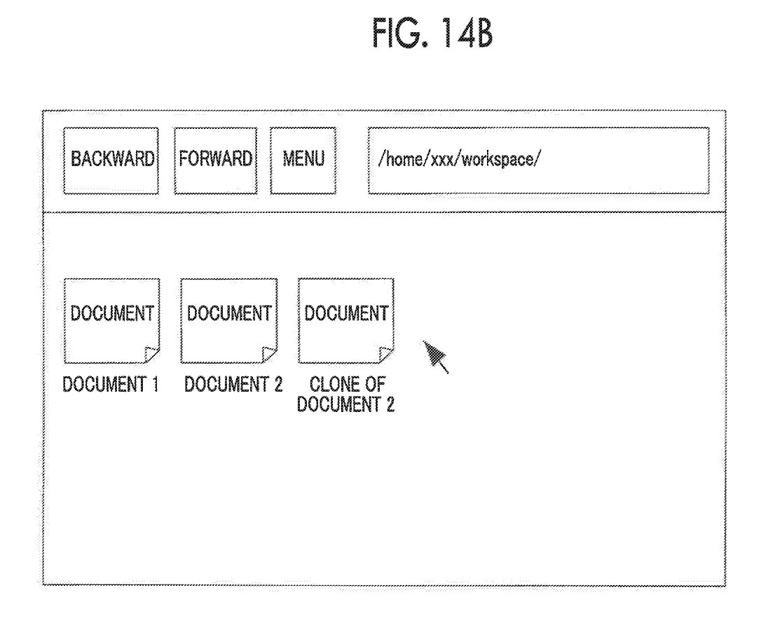

As a specific example of allowing the client computer 14 to issue the instruction to copy document information, as illustrated in FIG. 14A, when a shortcut of document information to be copied is selected and a menu button 70 or the like is clicked, a copy instruction (“file copy” of FIG. 14A) may be displayed so as to be selectable. Then, upon detecting the operation on the copy instruction, the document management server 12 copies the document information, and the client computer 14 copies the shortcut as illustrated in FIG. 14B (see clone of document 2).

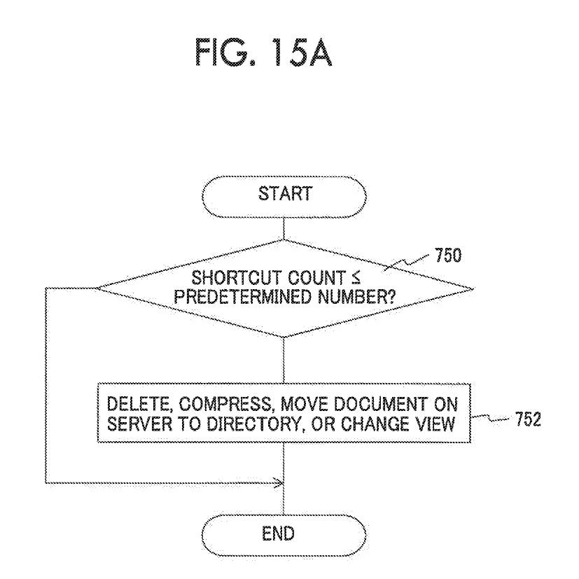

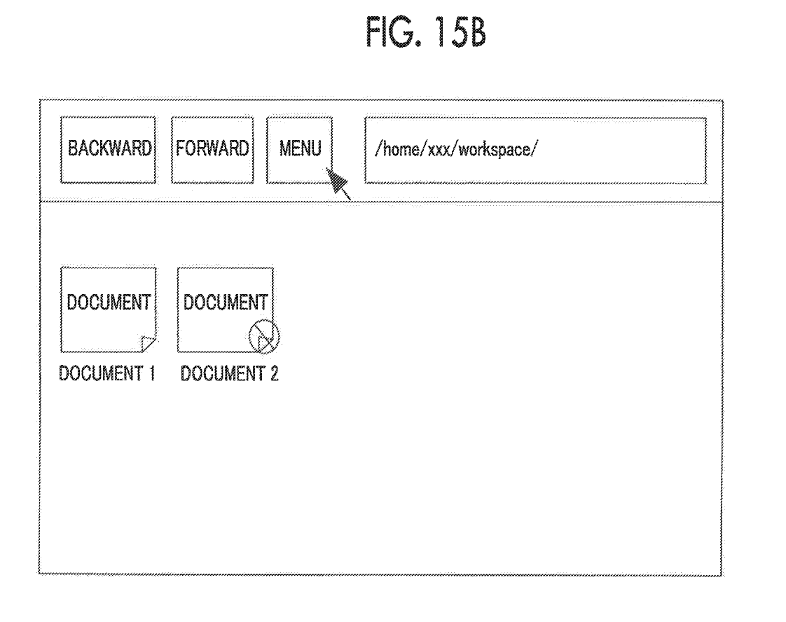

Next, the document organizing process will be described. FIG. 15A is a flowchart illustrating an example of the flow of the document organizing process, and FIG. 15B is a diagram illustrating an overview of the flow of the document organizing process.

In step 750, the document management server 12 determines whether the number of shortcuts is a predetermined number or smaller. For example, when an instruction to delete a shortcut is received via a client application, and the instruction is detected, the document management server 12 monitors the number of shortcuts with respect to one item of document information. When a negative determination result is obtained, the process ends, and another process is performed. When a positive determination result is obtained, the flow proceeds to step 752.

In step 752, the document information on the document management server 12 is deleted, compressed, or moved to a directory, or the display thereof is changed, and the process ends.

That is, since the document information of which the shortcut is deleted from the client computer 14 may be treated as a document which is directly referred to from nobody, when the document is deleted, compressed, or moved to another directory, or the display thereof is changed, it is possible to specify that the document is less frequently used.

Moreover, when the document is deleted or compressed, the storage capacity of the document management server 12 is secured, and the storage may be efficiently used.

As an example of specifying that the document is less frequently used, as illustrated in FIG. 15B, the document management server 12 displays a list of documents stored in the document management server 12 using a browser or an application of the client computer 14. Moreover, when the document list is displayed, an icon of the document information of which the number of shortcuts is a predetermined number or smaller (for example, zero) is modified and displayed (see the icon of document 2 of FIG. 15B). Moreover, when a shortcut is created for a modified icon of a document of which the number of shortcuts is small, the modified icon is restored to the original icon.

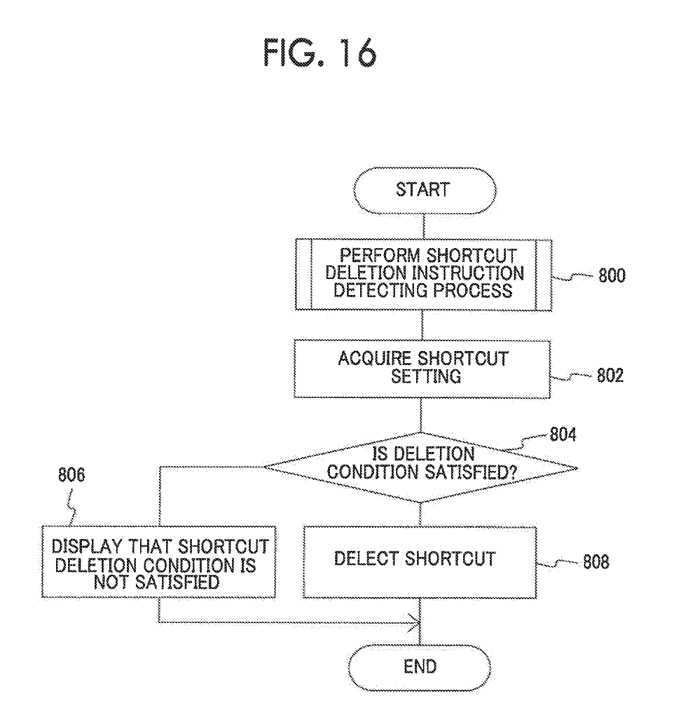

Next, the deleting process will be described. FIG. 16 is a flowchart illustrating an example of the flow of the deleting process.

In step 800, a process of detecting a shortcut delete instruction is performed, and the flow proceeds to step 802. The shortcut delete instruction is detected by determining whether the client computer 14 has instructed to delete a shortcut.

In step 802, shortcut setting is acquired, and the flow proceeds to step 804. The shortcut setting acquired herein is the setting on the condition for deleting a shortcut, which is set in advance according to an operation. Examples of the setting on the shortcut deletion condition include a setting in which all shortcuts may not be deleted, a setting in which all shortcuts may be deleted, a setting in which a shortcut created when a document is created may not be deleted, but the copy thereof may be deleted, and a setting in which a deletion inhibiting flag is prepared in a property of the shortcut, and the shortcut is deleted according to the inhibition flag. The content of the setting which is set in advance is acquired in step 802.

In step 804, it is determined whether the deletion condition is satisfied. When a negative determination result is obtained, the flow proceeds to step 806. When a positive determination result is obtained, the flow proceeds to step 808.

In step 806, a note that the shortcut deletion condition is not satisfied is displayed. That is, it is prevented from deleting the shortcut erroneously.

In step 808, the shortcut is deleted, and the series of processes ends.

Whether a shortcut maybe deleted or not may be set using a property of the document information on the document management server 12. Alternatively, a right may be given to a user, and the shortcut may be deleted depending on whether the user has the right to delete the same. Alternatively, the number of shortcuts may be acquired from the document management server 12, and the shortcut may be prevented from being deleted when the number of shortcuts is smaller than a predetermined number. The information on the owner of a document may be acquired from the document management server 12 so that the owner of the document may not delete the shortcut. Here, the owner is identified based on user information, terminal information, or shortcut information.

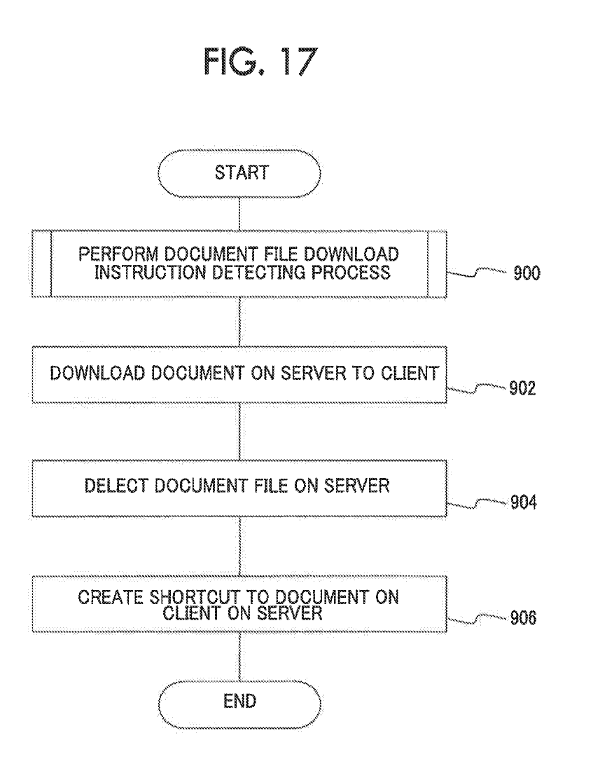

Next, the document file acquiring process will be described. FIG. 17 is a flowchart illustrating an example of the flow of the document file acquiring process.

In step 900, a process of detecting a document file download instruction is performed, and the flow proceeds to step 902. This process is performed by determining whether there is an instruction to download document information of a document file.

In step 902, the document information on the document management server 12 is downloaded on the client computer 14, and the flow proceeds to step 904.

In step 904, the document file information on the document management server 12 is deleted, and the flow proceeds to step 906.

In step 906, the shortcut to the document on the client computer 14 is generated on the document management server 12, and the series of processes ends.

That is, the document information on the document management server 12 is moved to the client computer 14, the document information itself is used as a document file, and the shortcut to the document file information on the clients 14 is left on the document management server 12. In this way, the ownership of the document information is changed to the client computer 14, and the client computer 14 may access the document via the document management server 12.

The document management program of the exemplary embodiment described above may be distributed by storing the same in various media and may be used by downloading the same from the Internet or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management server comprising:
a memory configured to store document information; and
a CPU configured to:
generate connection information including (i) information for accessing an entire document stored in the memory and (ii) identification information for identifying the entire document when multiple documents having a file name the same as that of the entire document are stored in the memory;
transmit the generated connection information to a document management device; and
monitor the number of items of the connection information and either compress the entire document or change a display of a graphic representing the entire document when the number of items of the connection information reaches a predetermined number.

2. The document management server according to claim 1, wherein the predetermined number is zero.

3. A non-transitory computer readable medium storing a document management program for causing a CPU to:
generate connection information including (i) information for accessing an entire document stored in a memory and (ii) identification information for identifying the entire document when multiple documents having a file name the same as that of the entire document are stored in the memory;
transmit the generated connection information to a document management device; and
monitor the number of items of the connection information and either compress the entire document or change a display of a graphic representing the entire document when the number of items of the connection information reaches a predetermined number.
